(19) United States
(12) Patent Application Publication
(10) Pub. No.: US 2024/0310511 A1
(43) Pub. Date: Sep. 19, 2024

(54) UNDERGROUND UTILITY DETECTION SYSTEM AND METHOD USING A MACHINE LEARNING ALGORITHM FOR PERFORMING UNDERGROUND UTILITY DETECTION

(71) Applicant: GEODAR INC, MONTREAL (CA)

(72) Inventors: Raphael LEBLANC, MONTREAL (CA); Charles GAUTHIER, SOREL-TRACY (CA); Dory HADAD, LAVAL (CA); Philippe GEUKERS, CANDIAC (CA)

(73) Assignee: GEODAR INC, MONTREAL (CA)

(21) Appl. No.: 18/599,883

(22) Filed: Mar. 8, 2024

Related U.S. Application Data
(60) Provisional application No. 63/490,087, filed on Mar. 14, 2023.

(51) Int. Cl. G01S 13/88; G01S 7/00; G01S 7/03

(52) U.S. Cl. CPC G01S 13/885; G01S 7/003; G01S 7/03

(57) ABSTRACT

The present provides an underground utility detection system comprising a ground penetrating radar, a Global Positioning System receiver, a processor, and a wireless communication module. The ground penetrating radar generates images of an underground area. The Global Positioning System receiver establishes a position of the ground penetrating radar. The processor collects the images generated by the ground penetrating radar and the position of the ground penetrating radar. The processor executes a machine learning algorithm determining at least one output based on inputs. The at least one output comprises a presence indicator indicating the presence or absence of an underground object. The inputs comprise the images collected. The wireless communication module wirelessly communicates the underground images to the processor.

### TECHNICAL FIELD

The present disclosure relates to the field of underground utility detection, and more particularly to an underground utility detection system, and a method using a machine learning algorithm for performing underground utility detection.

### BACKGROUND

Excavating in the vicinity of underground utility is a challenging and dangerous activity. Incidents regularly happen resulting in damaging the public utility equipment. Accidents also happen when excavation results in damaging a gas pipe resulting in gas leaks and sometimes explosions.

Current underground utility locating services provide to an operator of an excavator maps locating the underground public utility. However, the located underground public utility is often not precise nor reliable.

The underground utility locating systems rely on ground penetration radar. An example of such a system is described in US2021033723 by Rodradar Ltd which describes a ground penetrating radar implement to be connected to an extent of an arm of an excavator to locate underground public utility. Although the described system allows detection of underground public utility, it requires the removal of the bucket to install in place thereof the proposed implement. Alternating between the implement and the bucket takes time and increases costs and delays. Furthermore, and in case of excavations in environments with dense underground public utilities, the switching of the implement and the bucket causes a loss of precision and great delays.

There is therefore a need for a new underground utility detection system and a method using a machine learning algorithm for performing underground utility detection.

### SUMMARY

According to a first aspect, the present disclosure relates to an underground utility detection system. The underground utility detection system comprises a ground penetrating radar, a Global Positioning System receiver, a processor, and a wireless communication module. The ground penetrating radar generates images of an underground area. The Global Positioning System receiver establishes a position of the ground penetrating radar. The processor collects the images generated by the ground penetrating radar and the position of the ground penetrating radar. The processor further executes a machine learning algorithm. The machine learning algorithm determines at least one output based on inputs. The inputs comprise the images collected by the processor. The at least one output comprises a presence indicator indicating the presence or absence of an underground object. The wireless communication module wirelessly communicates the images to the processor.

According to a second aspect, the present disclosure relates to a switchable magnetic attachment for affixing a ground penetrating radar to a ferromagnetic structure of a heavy equipment. The switchable magnetic attachment comprises a receptacle for receiving the ground penetrating radar. The switchable magnetic attachment further comprises a switchable magnet adapted to attach to the ferromagnetic structure of the heavy equipment when actuated and to detach from the ferromagnetic structure of the heavy equipment when deactivated. The switchable magnet being mechanically actuated and deactivated.

According to a third aspect, the present disclosure relates to a heavy equipment. The heavy equipment comprises a ground penetrating radar, a Global Positioning System receiver, a processor, and a wireless communication module. The ground penetrating radar generates images of an underground area under the ground penetrating radar. The Global Positioning System receiver is adapted for establishing a position of the ground penetrating radar. The processor collects images generated by the ground penetrating radar and the position of the ground penetrating radar. The processor executes a machine learning algorithm for determining at least one output based on inputs. The at least one output comprises a presence indicator indicating the presence or absence of an underground object. The inputs comprise the images collected. The wireless communication module communicates at least one of the following: the measurement signals, the position of the ground penetrating radar.

According to a fourth aspect, the present disclosure relates to a method using a machine learning algorithm for performing underground utility detection. The method comprises collecting, by a processor, images generated by a ground penetrating radar. The method comprises executing by the processor a machine learning algorithm. The machine learning algorithm uses a predictive model for determining at least one output based on inputs. The at least one output comprises a presence indicator indicating the presence or not of an underground object. The inputs comprise the images generated by the ground penetrating radar.

### BRIEF DESCRIPTION OF THE DRAWINGS

Embodiments of the disclosure will be described by way of example only with reference to the accompanying drawings, in which:

FIGS. 1A-1D illustrate exemplary functional implementations of attachment 100;

FIG. 2 illustrates an underground utility detection system 200;

FIG. 3 illustrates an exemplary functional diagram of a heavy equipment 10 equipped with the underground utility detection system 200;

FIG. 4 illustrates a machine learning algorithm for performing underground utility detection;

FIG. 5 illustrates a schematic representation of components of the computing device of FIGS. 1D, 2 and 3;

FIG. 6 illustrates a method using machine learning to perform underground utility detection; and

FIG. 7 illustrates a neural network implementing the machine learning algorithm of FIG. 4.

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

Various aspects of the present disclosure generally address the needs of the field of underground utility detection and describe a system and a heavy equipment equipped with an underground utility detection system, a switchable magnetic attachment for a ground penetrating radar, a heavy equipment and a method using a machine learning algorithm for performing underground utility detection.

Throughout the present description, the following expressions are used as follows:

Heavy equipment: any machinery used in the field of underground utility such as for example excavating, digging, probing, and drilling.

Ferromagnetic structure: any structure of a heavy equipment such as for example an arm, a bucket, a drill, or any other structure which is ferromagnetic, i.e., strongly attracted by a magnetic field.

Ground penetrating radar: device sending radio signal(s) into a ground area, receiving radio signal(s) bouncing off object(s) in the ground area and generating therefrom images.

Machine learning algorithm: supervised and/or unsupervised algorithm, including deep learning algorithm, neural networks, image processing algorithm, image recognition algorithms, clustering algorithms, etc.

Switchable magnet: type of magnet that can be switched on or off to allow easy repositioning.

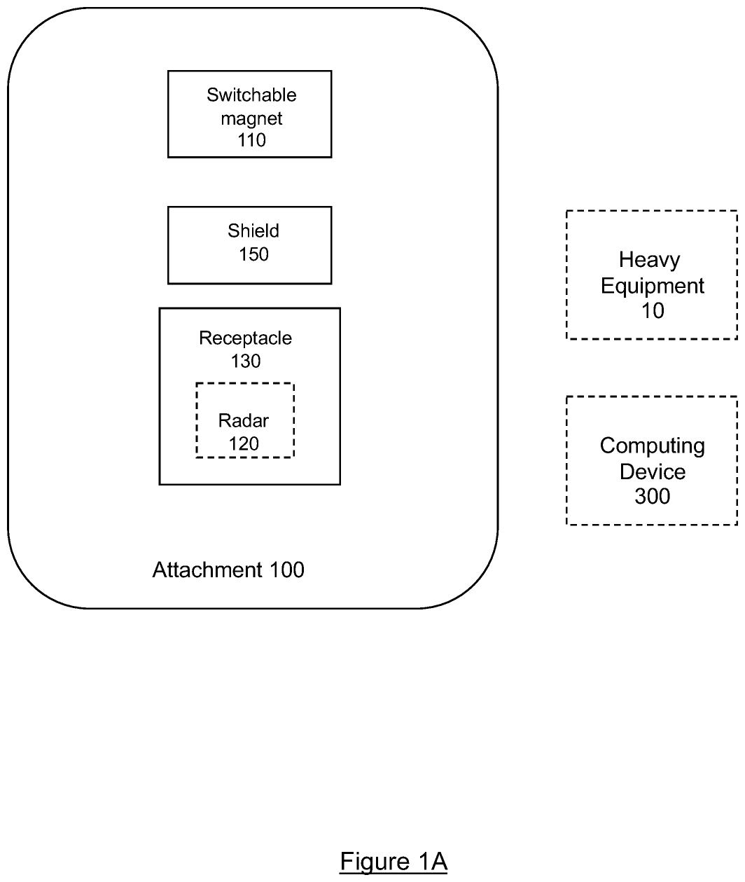

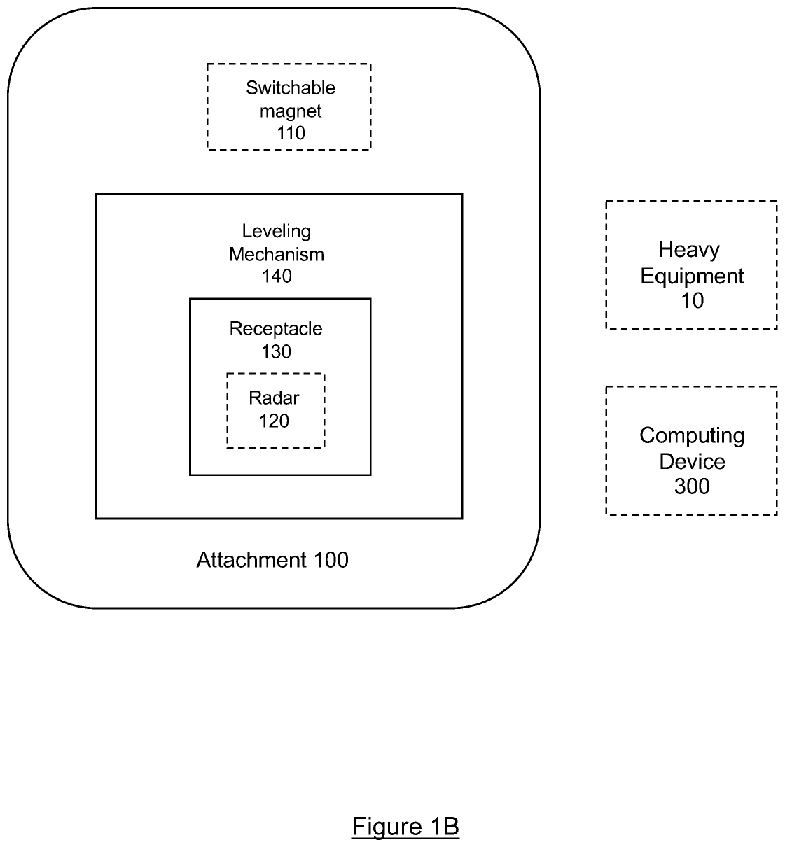

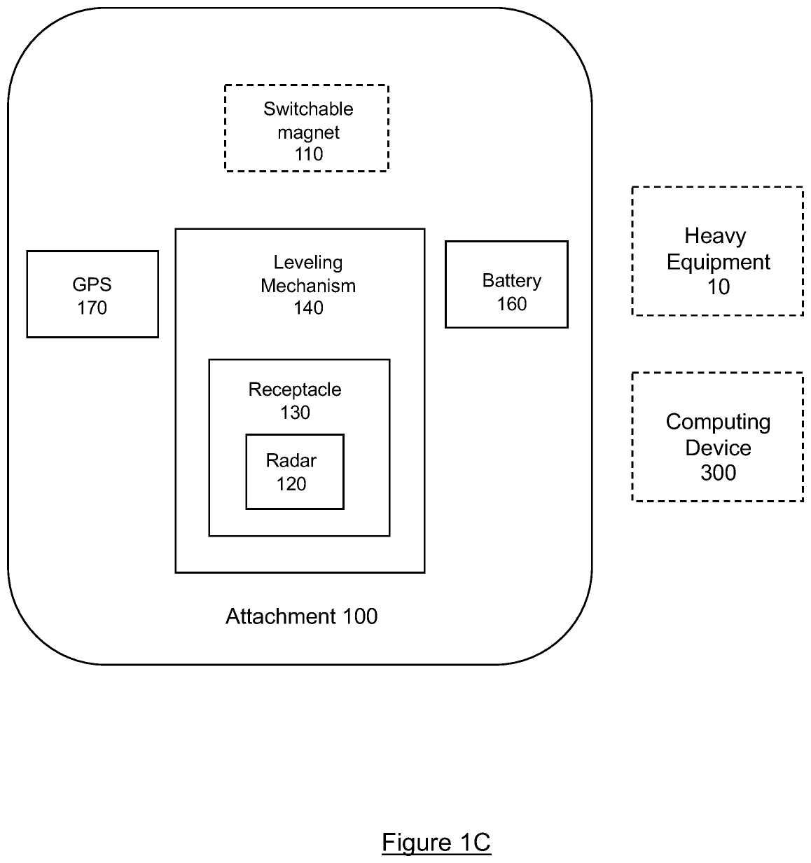

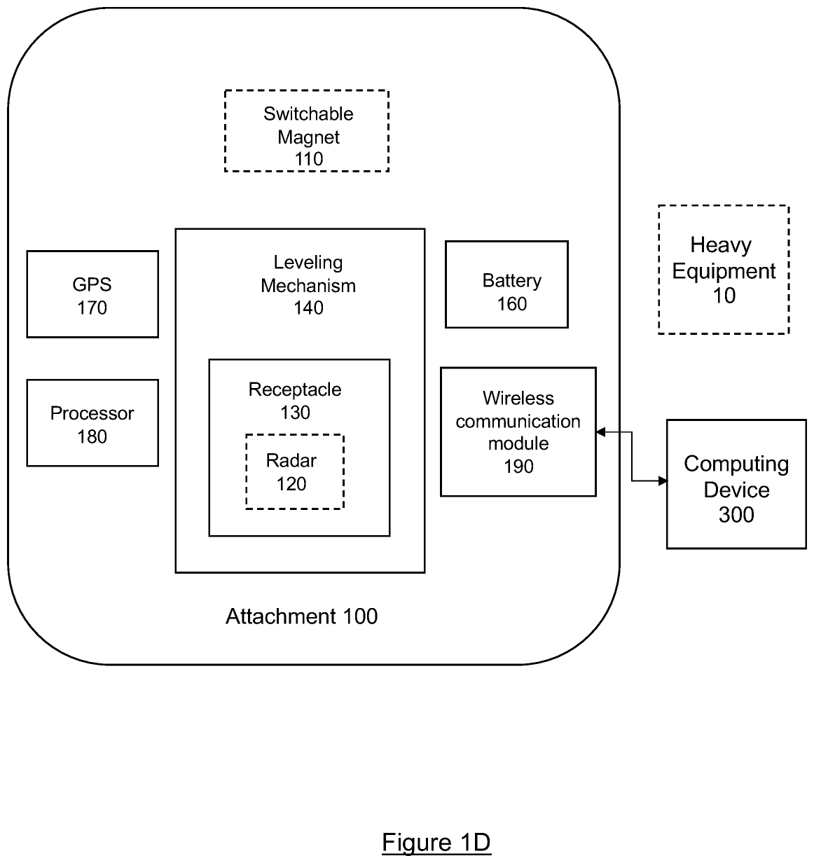

Referring to FIG. 1A, there is shown an attachment 100. The attachment 100 is adapted for affixing a radar 120 to a ferromagnetic structure of a heavy equipment 10. The attachment 100 comprises a switchable magnet 110 and a receptacle 130.

Switchable magnets are well known in diverse industries and are manually actuated and deactivated. When actuated, the switchable magnet 110 generates a magnetic field to attach to a ferromagnetic structure of a heavy equipment 10 when actuated and to detach from the ferromagnetic structure of the heavy equipment 10 upon deactivation. For example, the switchable magnet 110 may be magnetically attached to an arm of the heavy equipment 10 and located on the arm to “sense” the area which is about to be worked by the heavy equipment. Using an attachment 100 comes with multiple advantages. First, the attachment 100 may be easily transferred from one heavy equipment to the next, or concurrently with various implements of the same heavy equipment 10. Second, the attachment 100 allows for quick repositioning to get a better coverage of the area to be worked. Those advantages increase security, productivity and costs reduction which are serious issues when working in the vicinity of underground utilities.

Alternatively, the receptacle 130 may be adapted to be temporarily or permanently affixed to the heavy equipment 10 instead of through the switchable magnet 110.

The receptacle 130 is adapted for receiving a ground penetrating radar 120. The receptacle 130 may be adapted for fixedly receiving the ground penetrating radar 120 or may provide access to the ground penetrating radar 120 to change or replace the ground penetrating radar 120, or to recharge the ground penetrating radar 120. Furthermore, the receptacle 130 may be adapted for protecting the ground penetrating radar 120 from the harsh conditions in which the heavy equipment 10 is used.

Ground penetrating radars are well known in the industry of underground utility detection. However, because ground penetrating radars are currently used as a separate implement rather than concurrently with the heavy equipment such as for example near a bucket, a drill or any other implement which may be used with the heavy equipment. With the present attachment 100, it is possible to quickly change, modify and reposition the ground penetrating radar 120 to improve security and productivity of heavy equipment operators.

In other embodiments, the ground penetrating radar 120 may be used concurrently with a depth sensor or any other type of sensor which may be used to improve security, productivity, and use of heavy equipment. Although not shown, the receptacle 130 could additionally receive multiple sensors 120 concurrently with the ground penetrating radar 120.

The ground penetrating radar 120 may be battery-operated and may be recharged by means of wires or wirelessly. Various technologies exist for recharging wirelessly, and any technology known in the art could be used herewith. Alternatively, the ground penetrating radar may be connected to the electricity provided by the heavy equipment 10 (e.g. battery, alternator).

Reference is now made concurrently to FIGS. 1A and 1B, the attachment 100 may further comprise a leveling mechanism 140 for leveling the ground penetrating radar 120. More particularly, the leveling mechanism 140 may be actuated when the switchable magnet 110 is actuated or independently of the actuation of the switchable magnetic 100. Alternatively, the leveling mechanism 140 may be a gravity-based mechanical level.

The attachment 100 may also include a magnetic shield 150 for protecting the ground penetrating radar 120 from a magnetic field generated by the switchable magnet 110 when actuated. The magnetic shield 150 may be provided directly on the switchable magnet 110, on or part of the receptacle 130 or independently of the switchable magnet 110 and the receptacle 130 and as a separate magnetic shield 150 provided therebetween.

Reference is now made concurrently to FIG. 1A-1C, where FIG. 1C illustrates another embodiment of the present attachment 100. In this embodiment, the attachment 100 further comprises a battery 160 for powering the ground penetrating radar 120. However, if the receptacle 130 is used with many sensors 120 concurrently, the battery 160 may alternatively or concurrently power the multiple sensors 120. Additionally, the battery 160 may further power the leveling mechanism 140.

Furthermore, FIG. 1C illustrates that the present attachment 100 may further include a Global Positioning System receiver (GPS) 170. The GPS 170 may be used for establishing a position of the ground penetrating radar 120.

Reference is now made concurrently to FIGS. 1A-1D, where the attachment 100 further comprises a processor 180 and a wireless communication module 190. The processor 180 is configured and adapted for receiving images generated by the ground penetrating radar 120 and generating signals to be wirelessly communicated by the wireless communication module 190. The processor 180 may further pre-process, treat or filter the images. The processor 180 may further be adapted for determining a battery level of the battery and communicating the battery level to the wireless communication module 190 for communication. The processor 180 may further generate signals for communicating the battery level and/or the GPS position. If other sensors are concurrently used, the processor 180 is further adapted for generating signals including measurements collected by the other sensors to be communicated by the wireless communication module 190.

The wireless communication module 190 wirelessly communicates using any of the wireless network protocols, such as for example protocols based on IEEE 802.11 family of standards. Alternately, the wireless communication module 190 may wirelessly communicate using any other known communication protocol or standard.

The processor 180 through the wireless communication module 190 exchanges with a computing device 300. The computing device 300 may be any type of electronic device such as for example a computer, a tablet, a smartphone, an onboard navigation system of the heavy equipment 10, etc. The computing device 300 may display the location of the underground utility as well as any other relevant information communicated (the images collected by the processor, the battery level, the position of the ground area from which the images were collected, etc.).

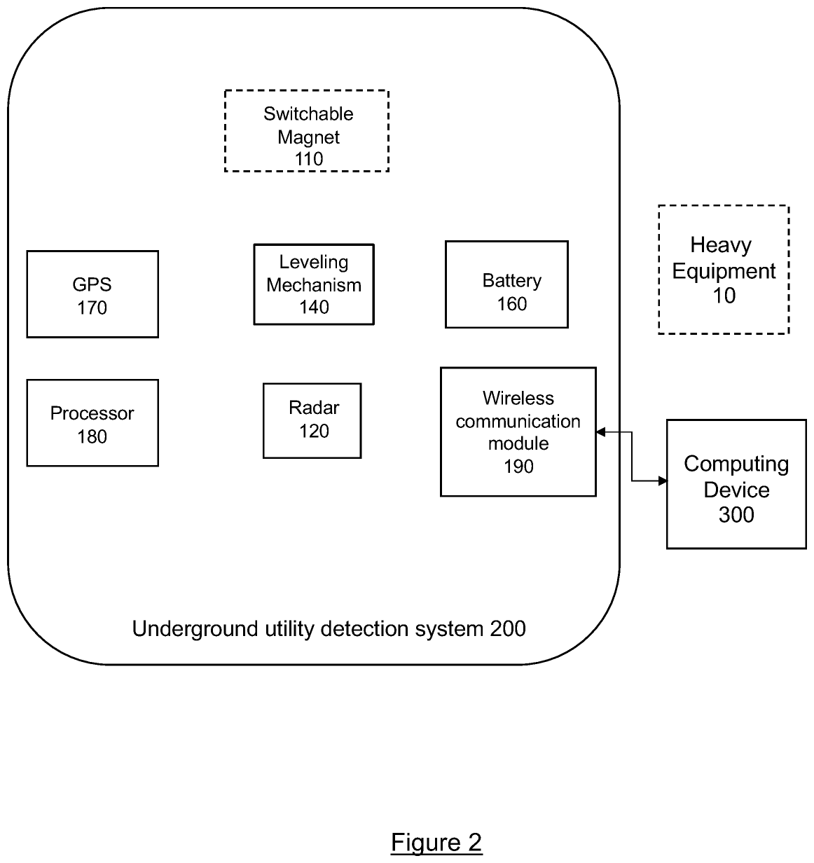

Reference is now made concurrently to FIGS. 1A-1D and FIG. 2, where FIG. 2 illustrates an underground utility detection system 200. The underground utility detection system 200 comprises the same elements as previously discussed for the attachment 100, with the difference that the ground penetrating radar 120 is not in a receptacle 130.

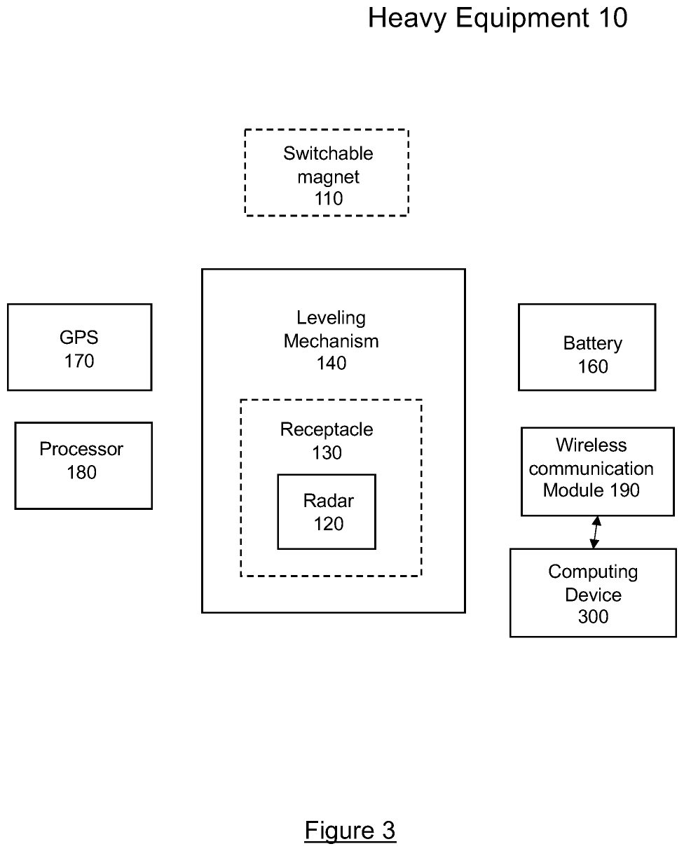

FIG. 3 illustrates the underground utility detection system 200 as part of the heavy equipment 10.

### Use of Machine Learning to Perform Underground Utility Detection

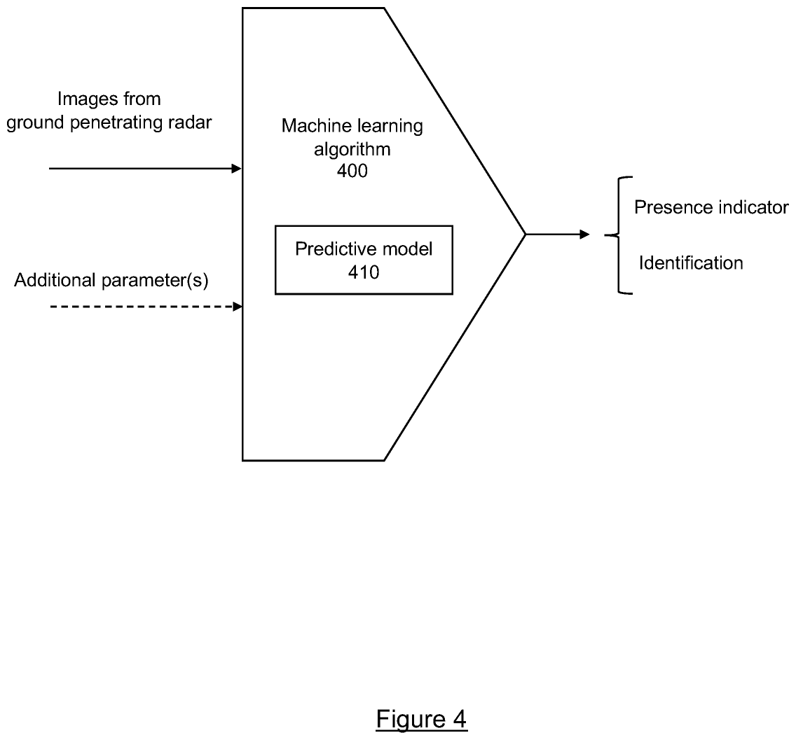

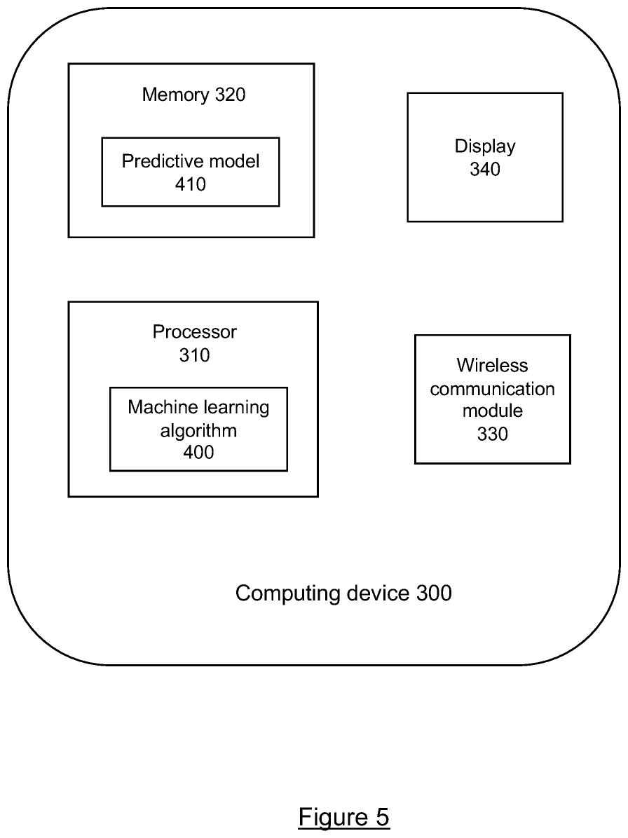

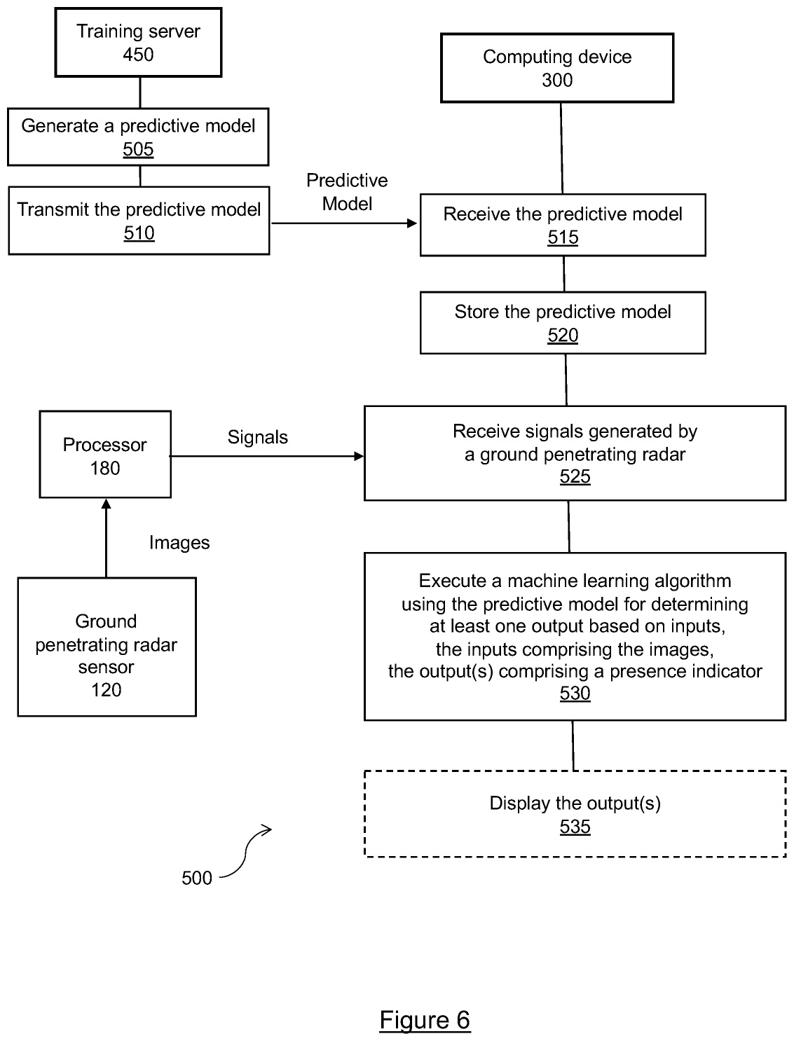

Reference is now made concurrently to FIGS. 1D, 2, 3, 4, 5 and 6. FIG. 4 illustrates a machine learning algorithm 400. The machine learning algorithm 400 uses a predictive model 410 for determining output(s) based on inputs. FIG. 5 is a schematic representation of components of the computing device 300. FIG. 6 represents a method 500 using machine learning to perform underground utility detection.

In a first implementation, the machine learning algorithm 400 is executed on the computing device 300. The computing device 300 comprises a memory 320 capable of storing the predictive model 410. The computing device 300 comprises a processor 310 capable of executing the machine learning algorithm 400. More specifically, the machine learning algorithm 400 is implemented by one or more computer programs comprising instructions executed by the processor 310. The computing device 300 comprises a wireless communication module 330 capable of receiving signals transmitted by the processor 180 of the attachment 100 or of the underground utility detection system 200 via the wireless communication module 190. The predictive model 410 determines at least one output based on inputs. At least some of the signals wirelessly received from the processor 180 are used as inputs of the machine learning algorithm 400 (e.g. the images generated by the ground penetrating radar 120).

In a second implementation, the machine learning algorithm 400 is directly executed by the processor 180 of the attachment 100 or of the underground utility detection system 200. The underground utility detection system 200 further comprises a memory (not represented in the Figures) for storing the predictive model 410. The machine learning algorithm 400 uses as inputs at least some of the images generated by the ground penetrating radar 120. The output(s) of the machine learning algorithm 400 are transmitted to the computing device 300 via the wireless communication module 190. In this second implementation, the attachment 100 and the underground utility detection system 200 transmit the output(s) of the machine learning algorithm 400 instead of transmitting the images of the ground penetrating radar 120.

A training server 450 executes step 505 by generating the predictive 410 model used by the machine learning algorithm 400. This step will be further detailed later in the description.

Following is a description of the steps of the method 500 represented in FIG. 6. FIG. 6 illustrates the first implementation, where the method 500 is executed by the computing device 300. To facilitate reading, the particulars of the second implementation are provided in square brackets below, when the method 500 is executed by the processor 180 of the attachment 100 or of the underground utility detection system 200.

The training server 450 executes step 510 by transmitting the predictive model 410 generated at step 505 to the computing device 300 [the processor 180].

The processor 310 of the computing device 300 executes step 515 by receiving the predictive model 410 via the wireless communication module 330 of the computing device 300. [The processor 180 of the attachment 100 or of the underground utility detection system 200 is provided with the predictive model 410 and receives updates therefor through the wireless communication model 190.]

The processor 310 of the computing device 300 executes step 520 by storing the predictive model 410 in the memory 320 of the computing device 300.

The processor 310 of the computing device 300 executes step 525 by receiving signals generated by the processor 180 for the images of the ground penetrating radar 120. [The processor 180 of the attachment 100 or of the underground utility detection system 200 executes step 525 by collecting images generated by the ground penetrating radar 120.] The images collected may be consecutive images, or non-consecutive images. The images may be collected in real-time, at intervals, or only upon demand. Therefore, in the rest of the description, we will refer to the images being generated by a ground penetrating radar for simplicity purposes, but this terminology should be interpreted broadly to refer to any of the alternatives of images mentioned and is not meant to limit the present description to consecutive images.

In an exemplary implementation of step 525, the receipt of signals consists in receiving the images at the computing device 300 via the wireless communication module 330, the images being received from the ground penetrating radar 120 by the processor 180 and transmitted by the processor 180 to the computing device 300 via the wireless communication module 190.

The processor 310 of the computing device 300 executes in step 530 the machine learning algorithm 400. The machine learning algorithm 400 uses the predictive model 410 for determining at least one output based on inputs. [The processor 180 of the attachment 100 and the underground utility detection system 200 executes in step 525 the predictive model 410.]

The output(s) of the machine learning algorithm 400 comprise a presence indicator as illustrated in FIG. 4. The presence indicator indicates the presence or not of an underground object, such as an underground public utility, in the ground. For example, the presence indicator is a Boolean taking the value True (for indicating the presence of an underground object) and False (for indicating the absence of an underground object). In another example, the presence indicator is a percentage indicative of the presence of an underground object (e.g. 95% of chances of presence). Alternatively, the percentage is indicative of the absence of an underground object (e.g. 95% of chances of absence).

Optionally, the output(s) of the machine learning algorithm 400 also comprise an identification as illustrated in FIG. 4. When the presence indicator indicates that an underground object is present in the ground, the identification of the detected underground object further identifies a type of the detected underground object among pre-defined types of objects. For example, in the context of the detection of underground pipes, following are examples of the types of pipes which can be identified by the machine learning algorithm 400 via the identification output: gas lines, aqueducts, sewer infrastructure, optic fibers, etc. Identification can also help reduce false positives by identifying buried debris or anomalies that do not important to avoid.

The output of the machine learning algorithm 400 may further consist of a 3-dimension image or a sequence of 3-dimension images to be displayed. The 3-dimension image(s) may be transmitted to a display in the heavy equipment 10. Alternatively, the 3-dimension image(s) may be transmitted with a GPS position of where the 3-dimension image(s) were taken to a server for processing and/or storing, or overlayed on a map of the ground area. The 3-dimension image(s) may further include an identification of the detected structure. For example, when multiple underground objects are concurrently detected, the output of the machine learning algorithm 400 may consist of a 3-dimension image or sequence of images to be displayed, where each image illustrates the shape, size and type of underground object, and the shape, size and type of underground object may be accompanied by a certainty value.

Alternatively, the output(s) of the machine learning algorithm 400 may also comprise a recommendation output, the recommendation output providing guidance to an operator of a heavy machinery using the ground penetrating radar. In another alternative, the output(s) of the machine learning algorithm 400 may also comprise an instruction output, the instruction output overriding control of the heavy machinery to stop movement of the heavy machinery to prevent an accident.

The inputs of the machine learning algorithm 400 comprise the images received at step 520 [collected at step 520]. The images are generated by the ground penetrating radar 120. The usual way to operate the ground penetrating radar 120 is to move it along a surface area of the ground being currently explored and to take a series of images at consecutive positions. Each series of images for a given position of the ground penetrating radar 120 comprises M measurements illustrated as pixels. The M measurements may correspond to a time delay measurement between an emission of a radio frequency (RF) signal and a reflection of the RF signal, a phase difference measurement between the emitted RF signal and the reflected RF signal, or any other type of measurement known and used in ground penetrating radar technology. Thus, each image illustrates multiple measurements of differences between the radio frequency (RF) signal emitted by the ground penetrating radar 120 and the reflected RF signal received at the ground penetrating radar 120. The frequency of the emitted RF signal may be different for each of the M measurements. A total of N series of measurements at N corresponding consecutive positions are generated. Thus, the inputs comprise M*N measurements generated by the ground penetrating radar 120, the M*N measurements being provided as a series of N images.

Further examples of measurements generated by the ground penetrating radar 120 and used as inputs of the machine learning algorithm 400 may comprise a variation of frequency between the emitted RF signal and the corresponding reflected RF signal, a variation of phase between the emitted RF signal and the corresponding reflected RF signal, or a combination thereof.

Alternatively, the inputs of the machine learning algorithm 400 only comprise a single series of M measurements performed at a given position provided as a single image.

Optionally, the inputs of the machine learning algorithm 400 may further comprise additional parameter(s). One example of additional parameters includes positional data generated by the GPS receiver 170 (or calculated based on the data generated by the GPS receiver 170). For example, in the case where the N series of measurements at N corresponding consecutive positions are used as inputs, position data for each of the N consecutive positions are also used as inputs.

The processor 310 of the computing device 300 executes optional step 535 by displaying the output(s) (e.g. the presence indicator) on the display 340 of the computing device. Alternative or complementary actions may also be taken at step 535, such as transmitting the output(s) (e.g. the presence indicator) to a remote computing device (not represented in the Figures).

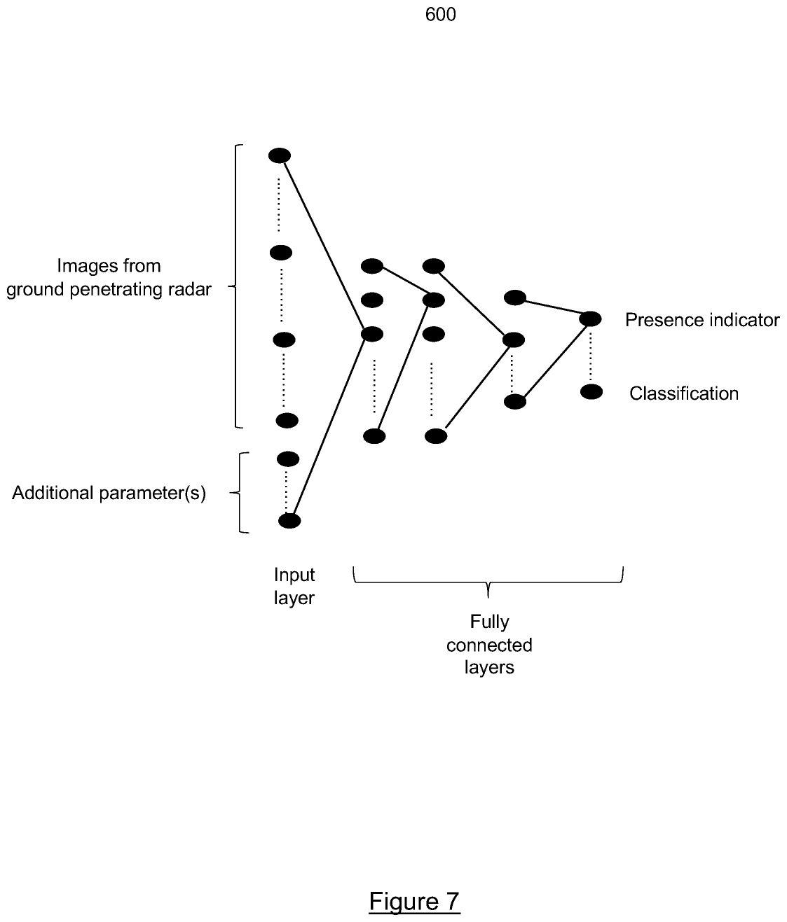

Reference is now made concurrently to FIGS. 4, 6 and 7, where FIG. 7 illustrates an exemplary implementation of the machine learning algorithm 400 of FIG. 4 by a neural network 600.

The neural network 600 illustrated in FIG. 7 is for illustration purposes only. A person skilled in the art will readily understand that other implementations of the neural network 600 may be used for performing step 530 of the method 500.

The neural network 600 includes an input layer for receiving the inputs, followed by a plurality of fully connected layers. The last layer among the plurality of fully connected layers is an output layer for outputting the output(s). The output(s) are generated by the neural network 600, by applying the predictive model 410 to the inputs.

The output(s) generated by the output layer comprise the presence indicator and optionally the identification. In the exemplary implementation of FIG. 7, one neuron of the output layer outputs the presence indicator (which may take the value of a Boolean or a percentage as mentioned previously). Another neuron of the output layer outputs the identification (which may take one a among a set of discrete values encoding the pre-defined types of detected object).

The inputs received by the input layer comprise the images (including measurements) from the ground penetrating radar 120 and optionally additional parameter(s), as described previously. The input layer comprises one neuron for receiving each and optionally one neuron for receiving each additional parameter.

The operations of the fully connected layers are well known in the art. The number of fully connected layers is an integer greater than 2, including the output layer (FIG. 7 represents four fully connected layers, including the output layer, for illustration purposes only). The number of neurons in each fully connected layer may vary. During the training phase of the neural network, the number of fully connected layers and the number of neurons for each fully connected layer are selected; and may be adapted experimentally.

In an alternative implementation not represented in FIG. 7, the neural network 600 comprises a convolutional layer, optionally followed by a pooling layer, for receiving (instead of the input layer illustrated in FIG. 7) and processing the images generated by the ground penetrating radar 120. The outputs of the convolutional layer and optional pooling layer are further processed by the fully connected layers. For example, the convolutional layer is used when M*N measurements are collected, as described previously. The M*N measurements are organized in a M*N input matrix, which is processed by the convolutional layer as an image.

Following is a description of a procedure for training the neural network 600 to generate the presence indicator and the optional identification. The training procedure is implemented by the training server 450 represented in FIG. 6. The training procedure is adapted to an implementation of the neural network 600 supporting step 530 of the method 500. The training procedure can be adapted by a person skilled in the art to other types of machine learning algorithms 400.

A processing unit of the training server 450 executes a neural network training engine (not represented in the Figures). The neural network training engine implements functionalities of a neural network, allowing to generate the predictive model 410 ready to be used by the neural network 600 (when performing step 530 of the method 500) at the end of the training, as is well known in the art.

The training procedure comprises a step of initializing the predictive model 410 used by the neural network implemented by the neural network training engine. The predictive model 410 comprises various parameters which depend on the characteristics of the neural network implemented by the neural network training engine. The predictive model 410 is stored in a memory of the training server 450.

The initialization of the predictive model comprises defining a number of layers of the neural network, a functionality for each layer (e.g. input layer, fully connected layer, etc.), initial values of parameters used for implementing the functionality of each layer, etc. For example, the initialization of the parameters of a fully connected layer includes determining the number of neurons of the fully connected layer and determining an initial value for the weights of each neuron. Different algorithms (well documented in the art) can be used for allocating an initial value to the weights of each neuron. A comprehensive description of the initialization of the predictive model is out of the scope of the present disclosure, since it is well known in the art.

The training procedure comprises an initial step of generating training data. The training data comprise a plurality of instances of inputs and a corresponding plurality of instances of expected output(s). Each instance of inputs comprises a set of values for the measurements from the ground penetrating radar 120 and for the optional additional parameter(s) on a per pixel basis. Each corresponding set of output(s) comprises expected value(s) for the presence indicator and optionally for the identification of the presence detected. The set of training data needs to be large enough to properly train the neural network.

The training data can be determined experimentally, using existing databases which identify and localize objects (e.g. pipes) buried underground in a localized area. The ground penetrating radar 120 is used to generate the plurality of instances of training inputs of the neural network 600, by collecting experimental measurements presented in the form of images for the localized area. The plurality of instances of expected output(s) of the neural network 600 are determined by using the information provided in the existing databases.

The training procedure comprises a step (I) of executing the neural network implemented by the neural network training engine, using the predictive model 410 to generate respective instances of calculated output(s) based on the instances of inputs of the training data.

The neural network implemented by the neural network training engine corresponds to the neural network 600 executed at step 530 of the method 500 (same number of layers, same functionality for each layer, same parameters used for implementing the functionality of each layer, etc.).

The training procedure comprises a step (II) of adjusting the predictive model 410 of the neural network implemented by the neural network training engine, to minimize a difference between the instances of expected output(s) and the corresponding instances of calculated output(s). For example, for a fully connected layer of the neural network, the adjustment comprises adjusting the weights associated to the neurons of the fully connected layer.

Various algorithms may be used for minimizing the difference between the expected output(s) and the calculated output(s). For example, the predictive model is adjusted so that a difference between the expected output(s) and the calculated output(s) is lower than a threshold (e.g. a difference of only 1% is tolerated).

The aforementioned steps of the training procedure correspond to step 505 of the method 500. At the end of the training procedure, the neural network is considered to be properly trained (the predictive model 410 of the neural network has been adjusted so that a difference between the expected output(s) and the calculated output(s) has been sufficiently minimized). The predictive model 410, comprising the adjusted parameters of the neural network, is transmitted to the computing device 300, as illustrated by step 510 of the method 500. Test data are optionally used to validate the accuracy of the predictive model 410. The test data are different from the training data used for the training procedure.

Various techniques well known in the art of neural networks can be used for performing step (II). For example, the adjustment of the predictive model 410 of the neural network at step (II) uses back propagation. Other techniques, such as the usage of bias in addition to the weights (bias and weights are generally collectively referred to as weights in the neural network terminology), reinforcement learning, supervised or unsupervised learning, etc., may also be used.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. An underground utility detection system, the underground utility detection system comprising:
a ground penetrating radar for generating images of an underground area;
a Global Positioning System receiver for establishing a position of the ground penetrating radar;
a processor for collecting the images generated by the ground penetrating radar and the position of the ground penetrating radar, the processor executing a machine learning algorithm, the machine learning algorithm determining at least one output based on inputs, the at least one output comprising a presence indicator indicating the presence or absence of an underground object, the inputs comprising the images collected; and
a wireless communication module, the wireless communication module wirelessly communicating the underground images to the processor.

2. The underground utility detection system of claim 1, further comprising a levelling mechanism for levelling the ground penetrating radar.

3. The underground utility detection system of claim 1, further comprising a switchable magnetic attachment for removably securing to the heavy equipment, the switchable magnetic attachment further comprising a magnetic shield for protecting the ground penetrating radar from a magnetic field generated by the switchable magnetic attachment when actuated.

4. The underground utility detection system of claim 3, wherein the ground penetrating radar is actuated upon actuation of the switchable magnetic attachment.

5. The underground utility detection system of claim 4, wherein the ground penetrating radar is actuated when the switchable magnetic attachment is actuated, and the levelling mechanism has levelled the ground penetrating radar.

6. The underground utility detection system of claim 4, wherein the switchable magnetic attachment is mechanically operated.

7. The underground utility detection system of claim 1, wherein the wireless communication module communicates using any of the wireless network protocols based on IEEE 802.11 family of standards.

8. A switchable magnetic attachment for affixing a ground penetrating radar to a ferromagnetic structure of a heavy equipment, the switchable magnetic attachment comprising:
a receptacle for receiving the ground penetrating radar; and
a switchable magnet adapted to attach to the ferromagnetic structure of the heavy equipment when actuated and to detach from the ferromagnetic structure of the heavy equipment when deactivated, the switchable magnet being mechanically actuated and deactivated.

9. The switchable magnetic attachment of claim 8, further comprising a leveling mechanism for leveling the ground penetrating radar when the switchable magnetic attachment is actuated.

10. The switchable magnetic attachment of claim 8, further comprising a magnetic shield for protecting the ground penetrating radar from a magnetic field generated by the switchable magnet when actuated.

11. The switchable magnetic attachment of claim 8, further comprising at least one of:
a battery for powering the ground penetrating radar;
a Global Positioning System receiver for establishing position of the ground penetrating radar;
a processor for receiving images generated by the ground penetrating radar and generating measurement signals to be wirelessly communicated, the processor further determining a battery level of the battery;
a wireless communication module in communication with the processor, the wireless communication module wirelessly communicating at least one of the following: the measurement signals generated by the processor, the position established by the Global Positioning System, the battery level of the battery.

12. The switchable magnetic attachment of claim 10, wherein the wireless communication module wirelessly communicates using any of the wireless network protocols based on IEEE 802.11 family of standards.

13. A heavy equipment comprising:
a ground penetrating radar for generating images of an underground area under the ground penetrating radar;
a Global Positioning System receiver for establishing position of the ground penetrating radar;
a processor for collecting the images generated by the ground penetrating radar and the position of the ground penetrating radar, the processor executing a machine learning algorithm, the machine learning algorithm determining at least one output based on inputs, the at least one output comprising a presence indicator indicating the presence or absence of an underground object, the inputs comprising the images collected; and
a wireless communication module for communicating at least one of the following: the measurement signals, the position of the ground penetrating radar.

14. The heavy equipment attachment of claim 13, wherein the attachment is a switchable magnetic attachment, the switchable magnetic attachment is adapted to attach to the ferromagnetic structure of the heavy equipment when actuated and to detach from the ferromagnetic structure of the heavy equipment when deactivated.

15. The heavy equipment attachment of claim 14, wherein the switchable magnetic attachment further comprises a leveling mechanism for leveling the ground penetrating radar when the switchable magnetic attachment is actuated.

16. The heavy equipment attachment of claim 14, wherein the switchable magnetic attachment further comprises a magnetic shield for protecting the ground penetrating radar from a magnetic field generated by the switchable magnetic attachment when actuated.

17. A method using a machine learning algorithm for performing underground utility detection, the method comprising:
collecting, by a processor, images generated by a ground penetrating radar; and
executing by the processor a machine learning algorithm, the machine learning algorithm determining at least one output based on inputs, the at least one output comprising a presence indicator indicating the presence or not of an underground object, the inputs comprising the images generated by the ground penetrating radar.

18. The method of claim 17, wherein the underground object is a pipe.

19. The method of claim 17, wherein the at least one output further comprises an identification of the underground object.

20. The method of claim 17, wherein the at least one output further comprises a position of the underground object.

21. The method of claim 17, wherein the at least one output further comprises a size of the underground object.

22. The method of claim 17, wherein the images are consecutive images produced by the ground penetrating radar.

23. The method of claim 17, wherein the images are a sample of the consecutive images produced by the ground penetrating radar.

24. The method of claim 19, wherein the machine learning algorithm is trained to further generate a recommendation output, the recommendation output providing guidance to an operator of a heavy machinery using the ground penetrating radar.

25. The method of claim 19, wherein the machine learning algorithm is trained to further generate an instruction output, the instruction output overriding control of the heavy machinery to stop movement of the heavy machinery to prevent an accident.

26. The method of claim 19, wherein the at least one output comprises a 3-dimension image to be displayed to a user.
